(19) United States
(12) Patent Application Publication
(10) Pub. No.: US 2017/0166462 A1
(43) Pub. Date: Jun. 15, 2017

(54) Compositions and Methods for the Removal of Sulfates and Metals From Waste Water

(71) Applicant: HPPE, LLC, Columbus, GA (US)

(72) Inventors: Ashoka V.R. Madduri, Columbus, GA (US); Christopher P. Gardner, Columbus, GA (US); Matthew B. Blackmon, Columbus, GA (US); Curtis J. Rodencal, Midland, GA (US); Charles E. Milliron, III, Coulumbus, GA (US); Sameer S. Vhora, Columbus, GA (US); Charles R. Landis, The Woodlands, TX (US); Sanket Gandhi, Columbus, GA (US)

(73) Assignee: HPPE, LLC, Columbus, GA (US)

(21) Appl. No.: 15/373,717

(22) Filed: Dec. 9, 2016

Related U.S. Application Data
(60) Provisional application No. 62/265,258, filed on Dec. 9, 2015.
(60) Provisional application No. 62/265,264, filed on Dec. 9, 2015.

(51) Int. Cl. C02F 1/52; C08L 5/02; C08L 99/00; C02F 1/54

(52) U.S. Cl. CPC C02F 1/5263; C02F 1/5236; C02F 1/54; C08L 5/02; C08L 99/00; C02F 2101/101

(57) ABSTRACT

The invention is directed to compounds, compositions and methods for the removal of contaminants from fluids and, in particular sulfates and/or metals from industrial waste water. Compounds and compositions of the invention contain polysaccharides and other organic molecules. These flocculating agents are safe and effective, requiring no special handling procedures. Flocculation compounds include biopolymers of dextran, modified dextran and blends of dextrans, plus other organic and/or inorganic molecules. With the addition of flocculants of the invention to waste water, contaminants such as sulfate and toxic heavy metals can be safely, easily and efficiently removed.

### REFERENCE TO RELATED APPLICATIONS

This application claims priority to U.S. Provisional Application No. 62/265,258 entitled “Biopolymers for Metal Flocculation” filed Dec. 9, 2015, and U.S. Provisional Application No. 62/265,264 entitled “Compositions and Methods for the Removal of Sulfate from Waste Water” filed Dec. 9, 2015, the entirety of both of which are hereby incorporated by reference.

### BACKGROUND

1. Field of the Invention

The present invention is directed to biopolymer formulations, compounds, compositions and methods for the removal of contaminants from fluids and, in particular, compounds, compositions, and methods for the removal of sulfates and/or metals from waste water by bioflocculation. In particular, the invention is directed to flocculant and flocculating agents of polysaccharides such as dextran containing acid groups plus, humic acid and inorganic compounds.

2. Description of the Background

The introduction of metals and other chemicals in industrial processes has resulted in production of massive effluents with huge amounts of contaminants such as toxic heavy metals and other unwanted chemicals. The increasing amounts of discharge containing these contaminants have many negative effects on receptive waters in environment. Unlike organic compounds, these pollutants are non-degradable and tend to accumulate in living organisms. Zn and Ni are among these metals, which are used most often in industries to produce stainless steel, metallic alloys, chargeable batteries, catalyzers, coins, casting and metallurgy. Ca, Zn, Ba, Pb, Ni, Cr, Mn, Mg, Al, Fe, Cu and more inorganic metal salts enter into environment through natural ways and human activities and cause pollution in environment.

Other contaminants of concern in fluids such as, for example, waste water include sulfate and sulfate salts and derivatives. Many industrial wastewaters, particularly hose associated with mining, mineral processing, and municipal sewage contains high concentrations of sulfate. These concentrations typically exceed the secondary drinking water standard of 250 mg/L and are subject to discharge limits between 250 and 2000 mg/L. Chemical precipitation can be effectively executed with the use of Ba(OH)₂. In practice because of the toxicity of barium salts that technique is not used. Most often lime Ca(OH)₂ is used with limited effects and large quantities of sludge production. Biological processes under anaerobic conditions convert sulfates into sulfides, which in turn can be removed (precipitated) as ferrous sulfide. In spite of extensive experience in the application of the biological sulfate reduction process, also in full technical scale, not all aspects are sufficiently explained. The main issue is the fate of sulfides; the produced sulfides have many chemical complexity problems in the water.

Flocculation with flocculants (i.e., flocculating agents) is a major phase in water treatment technology for the exclusion of both organic and inorganic pollutants. Flocculants are substances used in the clumping of colloids, cells and suspended solids into larger size particles, referred to as flocs, that can be removed effectively from solution by sedimentation and/or other processes known to those skilled in the art. Important applications of flocculants are in downstream processing in the mining and fermentation industries, as well as drinking and waste-water treatment facilities. Flocculants may be categorized into three groups: organic flocculants, such as polyacrylamide derivatives; inorganic flocculants, such as polyaluminum chloride and ferric chloride; and naturally occurring flocculants, such as chitosan, sodium alginate and bioflocculants. The choice of flocculants has a major influence on the performance of the flocculation process.

Bioflocculants stands out among others, as they have the advantages of innocuousness, biocompatibility, biodegradability and environmental friendliness, unlike organic and inorganic flocculants, which are toxic and whose degradation intermediates are difficult to remove from the environment. Besides, organic flocculants, such as polyacrylamide and polyethylene imine derivatives and inorganic flocculants, have been implicated in adverse human health effects. An outstanding example is aluminum salts, which have been suggested to cause Alzheimer's disease in humans. Conversely, the enormous advantages associated with bio-flocculants motivates their consideration as an alternative, hence the vast interest in the scientific and industrial community worldwide.

Bioflocculants are largely composed of macromolecular substances, such as, for example, polysaccharides, protein, lipids and/or nucleic acids. The chemical composition and flocculating efficiency of bioflocculants depend on various factors, including the nature of the environment in which bioflocculant-producing microorganisms are isolated, the media compositions in which the microorganisms are cultivated, the functional groups, and molecular weight of the biopolymer. Several studies have demonstrated the efficiencies of bioflocculants in the treatment of drinking/waste water and other downstream processing.

Nevertheless, low flocculating efficiency, low yields and high cost of production compared with the conventional flocculants are major limitations to large-scale production and application of bioflocculants. Accordingly, there is a need for a safe and effective procedure for removing contaminants in a variety of industrial and other conditions.

### SUMMARY OF THE INVENTION

The present invention overcomes the problems and disadvantages associated with current strategies; and designs and provide novel compounds, compositions and methods for the removal of contaminants from fluids such as waste water.

One embodiment of the invention comprises flocculants that are comprised of a polymer that is preferably a polysaccharide. Preferred polysaccharides contain one or more acid groups and/or salts of the one or more acid groups. Preferably the polysaccharide comprises dextran, guar gum, scleroglucan, welan, xanthan gum, schizophyllan, levan, pullulan, cellulose, modified polysaccharides, blended polysaccharides, and/or combinations thereof. Also preferably, the one or more acid groups or salts of the one or more acid groups contain a carbon linker (C1-C6). The polymer of the invention may further comprise one or more diacid groups or salts of the one or more diacid groups as side chains. Preferably the combination of polysaccharide diacid with humic acid for flocculation of contaminants of a fluid.

Another embodiment of the invention comprises methods of removing contaminants from fluids such as, for example, wastewater. The method comprises contacting the waste water with a flocculant of the invention, preferably followed by thorough mixing, and allowing for the formation of floc containing the contaminants, and removing the flocs. Flocs can be removed by filtration, sedimentation, centrifugation and/or other method well known to those skilled in the art.

Prior to the addition of flocculant, fluids to be decontaminated according to the invention may be pretreated with calcium oxide, calcium hydroxide, periodate, zinc acetate and/or combinations thereof.

Another embodiment of the invention is directed to methods for removal of sulfur and sulfur-containing compounds from a waste water. The method comprises contacting the waste water with a flocculant of the invention, allowing the flocs to precipitate and removing the flocs.

Another embodiment of the invention is directed to methods for removal of metal and metal-containing compounds from a waste water. The method comprises contacting the waste water with a flocculant of the invention, allowing the flocs to precipitate and removing the flocs.

Other embodiments and advantages of the invention are set forth in part in the description which follows, and in part, may be obvious from this description, or may be learned from the practice of the invention.

### DESCRIPTION OF THE DRAWINGS

FIG. 1 Mine water flocculation showing flocculation and settled flocs.

FIG. 2 Graph showing sulfate removal with flocculation protocol.

### DESCRIPTION OF THE INVENTION

A conventional process for removal of contaminants from fluids such as waste water can involve flocculation. However, low flocculating efficiency, low yields and high cost of production are major limitations to large-scale production and application of bioflocculants. In addition, many flocculants are not safe for handling and require specialized instruction for removal of contaminants from a variety of industrial processes.

New compounds, compositions and chemical processes for the coagulation and removal of contaminants by flocculation have been surprisingly discovered. These processes preferably involve removal by flocculation using flocculating agents such as polysaccharide polymers and humic acid. Polymers are preferably dextran, modified dextran, and blends of dextran plus other inorganic molecules and/or inorganic molecules. Preferred polymers are acidified, such as, for example, polysaccharide acids, diacids and/or polyacids. The polymers may be mixed with the fluid in a specific order to generate highly efficient flocculation. Flocculating compounds and compositions of the invention are safe to work with, generally harmless to the environment and readily biodegradable. Additional organic and/or inorganic chemicals may be included in a flocculant composition that can be utilized to further enhance flocculation by promoting nucleation such as, for example, calcium oxide (i.e., line), calcium hydroxide, periodate, zinc acetate, carbamate, carbamic acid salts and/or alkyl carbamates, or combinations thereof. The efficiency of pre-treatment floc nucleation additives is estimated to be 10-30× less than the processes of the invention described herein. Overall, the methods of the invention described herein reduce waste volumes of both, high-density carbonate sludge and non-compliant brines.

One embodiment of the invention is directed to a composition comprising polymers of a polysaccharide, humic acid, and optionally one or more organic and/or inorganic compound. Preferably the polysaccharide comprises one or more of dextran, guar gum, scleroglucan, welan, pullulan, xanthan gum, schizophyllan, levan, cellulose, modified polysaccharides, blended polysaccharides, and/or combinations thereof. Polymers comprising, for example, dextran include dextran, modified dextran (e.g., dextran phosphate, dextran sulfate), and blends and combinations of different types of dextrans. Optionally, the polymer may contain substitutions of from 0-100 percent of the monomers of the polymer. Preferably, the polysaccharide contains one or more acidic groups (acidified), and the one or more acidic groups comprises at least one diacid group and/or multiacid group. Also preferably the one or more acidic groups contain one or more carbon linkers. Preferred flocculating compositions comprises acidified dextran (e.g., dextran diacid or polyacid) plus humic acid, dextran sulfate plus humic acid, or dextran phosphate plus humic acid.

Preferably, flocculation compositions may further comprise organic and/or inorganic chemicals. Preferred organic chemical include, but are not limited to carbamate, carbamic acid salts and/or alkyl carbamates. Preferred inorganic chemicals include calcium oxide (i.e., line), calcium hydroxide, periodate, zinc acetate, potassium oxide or hydroxide, and combinations thereof. Optionally, functional groups can be added as side chains to the polymer. Functional groups include groups that increase flocculation efficiency, and also functional groups that provide specific benefits to the fluid, such as, for example, adjusting or controlling pH, providing cleavage points and/or that provide industrial and/or environmental benefits to the waste water or the flocculation.

Preferably flocculation compositions may further comprise an additive, such as, for example, a surfactant, a defoaming agent, detergents, chelators, a buffer and/or combinations thereof. The polymer, with or without substitution, plus humic acid is preferably pre-mixed with the inorganic compounds. The resulting composition when used as a flocculant removes contaminants such as sulfur, forms of sulfur such as sulfate, vitamins, minerals, metal and metal compounds, and other contaminants by precipitating as a floc which is easily removed.

Another embodiment of the invention is directed to chemical processes for the coagulation and flocculation of contaminants from a fluid such as, for example, waste water. Contaminants include, for example, metals (e.g., heavy metals, toxic metals, compounds containing metals), minerals, sulfur and sulfur-containing compounds (e.g., sulfate), toxic compounds, large organic molecules, vitamins, pharmaceutical compounds and their metabolic products, suspended solids and combinations thereof. Preferably a flocculating agent of the invention is added to the target fluid such as, for example, industrial and/or environmental waste water. Thorough mixing is preferred and the contaminant precipitates by flocculation in the form of flocs. Mixing can be performed by stirring, shaking, agitation, vortexing, or another mixing method known to those skilled in the art and is preferably vigorously performed to ensure thorough mixing. The formation of flocs is generally immediate, although the mixture may be allowed to stand for minutes to hours without loss of efficiency to ensure maximum contaminant removal of flocs, which do not easily dissolve back into the fluid. Flocculation is also relatively pH and/or temperature independent. Preferred waste water pH ranges are from mildly to strongly acidic or neutral. Preferred temperatures ranges are from 4° C. to 35° C. Removal of flocs can be performed by filtration, sedimentation, centrifugation or another method known to one skilled in the art.

Preferred flocculants for metal removal include, and are not limited to, a dextran (e.g., acidified dextran, dextran diacid, dextran sulfate, dextran phosphate) plus humic acid. Preferred flocculants for sulfate removal include, and are not limited to, a dextran (e.g., acidified dextran, dextran diacid), humic acid and calcium oxide or hydroxide. Preferably the calcium oxide or hydroxide is added first, followed by the flocculant of a dextran plus humic acid.

Optionally, the fluid may be pretreated with additives such as inorganic materials and preferably calcium oxide or hydroxide, to promote nucleation. The efficiency of pre-treatment floc nucleation additives is estimated to be 10-50× less than the techniques described herein. In contrast, the compositions and methods of the invention reduce waste volumes of both, high-density carbonate sludge, preferably by 50-90%, and non-compliant brines preferably by 90% or more.

Another embodiment of the invention comprises the addition of calcium oxide or hydroxide to waste water followed by the addition of a flocculant of the invention. Preferably calcium oxide/hydroxide is added to the waste water from minutes (e.g., 1, 2, 3, 4, 5, 10, 15, 20, 30) to hours (e.g., 1, 2, 3) prior to the addition of the flocculant. There is no loss of efficiency in extending the time period between the additions. Preferably the flocculant composition comprises dextran diacid and humic acid. Alternatively, flocculant and calcium oxide/hydroxide may be added together.

The following examples illustrate embodiments of the invention, but should not be viewed as limiting the scope of the invention.

### EXAMPLES

### Example 1

### Sulfate Removal from Waste Water

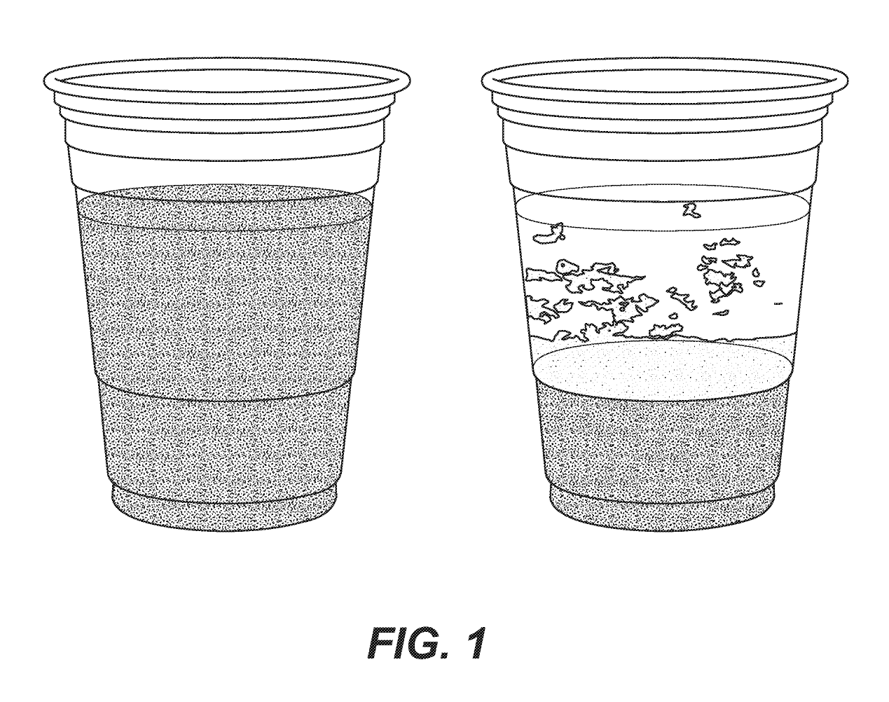

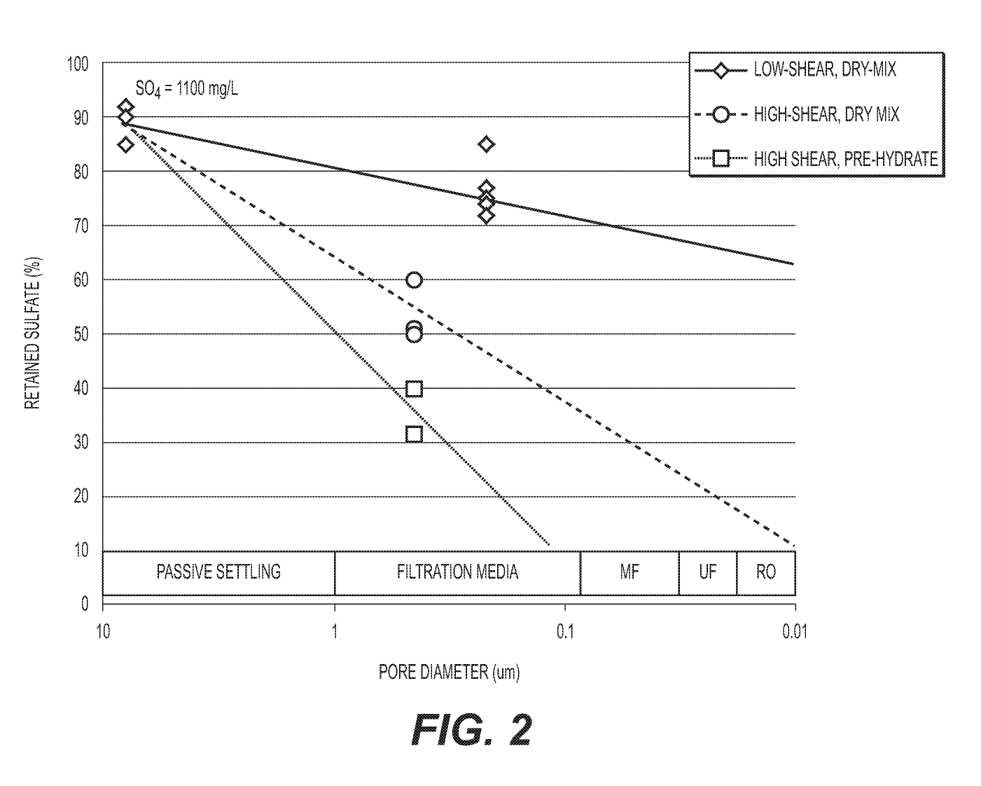

An experiment was conducted at ambient temperatures to determine the amount of sulfate that could be removed from waters using a sequential treatment of calcium binder and biopolymer using several types of mixing regimes for the calcium binders. Dry calcium powder additions mixed at less than 1000 rpm and mixed at >5000 rpm were compared to controlled additions of “slaked” lime to the same sulfate laden waters. The slake lime slurries were mixed at high rpm as a 50% solids slurry then injected into the sulfate waters at a significantly lower concentration than the dry blends. In the dry blends, 838 g of the sulfate water (either waste water or synthetic) and 164.25 g of CaO (CaO is also referred to as quicklime or burnt lime), the solution was stirred to ensure complete binding of Ca and SO₄. In the slake lime slurries 40-50 g were used. Four different 250 mL graduated cylinders were set up and 200 mL of the Ca and SO₄ solution poured into each containing a water sample. Mixing was less than two minutes for all treatments. Brown flocs developed and settled. Once the flocs settled, calcium binder polysaccharide diacid and humic acid polymer (e.g., flocculant) was added in 0.5 gpt (grams for thousand grams). The floc created by the calcium binder was allowed to settle and the supernatant water layer was filtered with 0.22 μm and 0.45 μm filter paper and then tested for sulfate content (FIG. 1 showing dispersed flocculation {left cup} and settled flocs {right cup }). Sulfate removal for each mixing protocols using calcium binder and enhanced flocculation development with biopolymers. The combination of high shear, slake lime shows higher removal rates through a sub-micron (0.45 μm) than the dry calcium addition protocols suggesting an improved interaction with the known treatment step and the new biopolymer. Additionally, the development of the sulfate floc with the biopolymer show that different filtration media sizes and configurations are possible. Standard UV-VIS spectrophotometer was used to measure the concentration of Sulfate ion and the results are shown in FIG. 2.

### Example 2

### Metals Removal from Waste Water

To test the capability of a composition comprising humic acid and dextran functionalized diacid to act as a flocculant and flocculate metals, 50 ppm of various metals (bonded to chloride) were added to 100 mL of deionized water (DI water). The product being tested was added at a dosage of 1 gpt to DI water with metal and stirred with a magnetic stirrer for 1 hour, all at ambient temperatures. After 1 hour, the magnetic stirrer was removed and the solution was allowed to settle for 1 hour. If a precipitate had formed and settled out, then the product was confirmed to be able to remove that metal from water. Results from that testing are shown in Tables 1 and 2.

TABLE 1

| Humic | | | | | |
|---|---|---|---|---|---|
| Acid/ | | | | | |
| Functionalized | | | | | |
| Dextran ratio | Ca | Ni | Pb | Mg | Zn |
| 1:1 | Pass the | Pass the | Pass the | Pass the | Pass the |
| | floc- | floc- | floc- | flocculation | flocculation |
| | culation | culation | culation | test | test |
| | test | test | test | | |

TABLE 2

| Humic | | | | | |
|---|---|---|---|---|---|
| Acid/ | | | | | |
| Functionalized | | | | | |
| Dextran ratio | Mn | Ba | Al | Cr | Fe |
| 1:1 | Pass the | Pass the | Pass the | Pass the | Pass the |
| | floc- | floc- | floc- | flocculation | flocculation |
| | culation | culation | culation | test | test |
| | test | test | test | | |

These results show that the composition of humic acid functionalized dextran precipitated every metal fnrm tested.

TABLE 3
Metal Removal Data

| Sample ID | Analyte | Result (mg/L) |
|---|---|---|
| CuT | Copper | 57.3 |
| CuU | Copper | 96.5 |
| ZnT | Zinc | 107 |
| ZnU | Zinc | 133 |
| PbT | Lead | 60.0 |
| PbU | Lead | 112 |
| FeT | Iron | 25.3 |
| FeU | Iron | 41.7 |

U = Untreated || T = Treated

As shown in Table 3, a composition comprising humic acid, dextran diacid and carbamate is effective in removing various metals and can be applied to other toxic metals that present in industrial waste water or back waters.

Other embodiments and uses of the invention will be apparent to those skilled in the art from consideration of the specification and practice of the invention disclosed herein. All references cited herein, including all publications, and all U.S. and foreign patents and patent applications are specifically and entirely incorporated by reference. The term comprising, where ever used, is intended to include the terms consisting and consisting essentially of. Furthermore, the terms comprising, including, and containing are not intended to be limiting. It is intended that the specification and examples be considered exemplary only with the true scope and spirit of the invention indicated by the following claims.

1. A flocculant comprising a polymer and a humic acid, wherein the polymer comprises a polysaccharide.

2. The flocculant of claim 1, wherein the polysaccharide comprises dextran, guar gum, scleroglucan, welan, xanthan gum, schizophyllan, pullulan, levan, cellulose, modified polysaccharides, blends of polysaccharides, and/or combinations thereof.

3. The flocculant of claim 2, wherein the modified polysaccharide comprises dextran sulfate, dextran phosphate, acidified dextran and/or combinations thereof.

4. The flocculant of claim 1, wherein the polysaccharide contains one or more acidic groups.

5. The flocculant of claim 4, wherein the one or more acidic groups comprises at least one diacid group.

6. The flocculant of claim 4, wherein the one or more acidic groups contain one or more carbon linkers.

7. The flocculant of claim 1, wherein the polymer contains substitutions of one or more monomers of the polymer.

8. The flocculant of claim 7, which contains substitutions of up to 100 percent of the monomers.

9. The flocculant of claim 1, further comprising one or more inorganic salts.

10. The flocculant of claim 9, wherein the one or more inorganic salts comprises calcium oxide, calcium hydroxide, periodate, zinc acetate or combinations thereof.

11. The flocculant of claim 1, further comprising one or more organic compounds.

12. The flocculant of claim 11, wherein the one or more organic compounds comprise carbamate, a carbamic acid salt, an alkyl carbamate and/or a combination thereof.

13. A method of removing one or more contaminants from waste water comprising:
contacting the waste water with a flocculant comprised of a polymer, humic acid and carbamate, a salt of carbamic acid and/or an alkyl carbamate, wherein the polymer comprises a polysaccharide, such that the one or more contaminants precipitate in the form of flocs; and
removing the flocs.

14. The method of claim 13, wherein the polysaccharide comprises dextran, dextran sulfate, dextran phosphate, acidified dextran and/or combinations thereof.

15. The method of claim 13, wherein the contaminant is a metal.

16. The method of claim 15, wherein the metal comprises Ca, Zn, Ba, Pb, Ni, Cr, Mn, Mg, Al, Fe, Cu and/or combinations thereof.

17. The method of claim 13, wherein the polysaccharide comprises a modified dextran.

18. The method of claim 17, wherein the modified dextran comprises dextran diacid.

19. The method of claim 13, wherein removing is by filtration, sedimentation, centrifugation or a combination thereof.

20. A method of removing one or more contaminants from waste water comprising:
contacting the waste water with calcium oxide or calcium hydroxide to form a mixture;
contacting the mixture with a flocculant comprised of a polymer and humic acid, wherein the polymer comprises a polysaccharide, such that the one or more contaminants precipitate in the form of flocs; and
removing the flocs.

21. The method of claim 20, wherein the one or more contaminants comprise sulfur and/or sulfur-containing compounds.

22. The method of claim 20, wherein the polysaccharide comprises a modified dextran.

23. The method of claim 22, wherein the modified dextran comprises acidified dextran.

24. The method of claim 23, wherein the acidified dextran comprises dextran diacid.

25. The method of claim 20, wherein removing is by filtration, sedimentation, centrifugation or a combination thereof.
